(19) United States
(12) Patent Application Publication
(10) Pub. No.: US 2023/0055511 A1
(43) Pub. Date: Feb. 23, 2023

(54) OPTIMIZING CLUSTERED FILESYSTEM LOCK ORDERING IN MULTI-GATEWAY SUPPORTED HYBRID CLOUD ENVIRONMENT

(71) Applicant: International Business Machines Corporation, Armonk, NY (US)

(72) Inventors: Abhishek Satyanarayan Dave, Pune (IN); John T. Olson, Tucson, AZ (US); Sasikanth Eda, Vijayawada (IN)

(21) Appl. No.: 17/407,339

(22) Filed: Aug. 20, 2021

(51) Int. Cl. H04L 29/08; H04L 12/26

(52) U.S. Cl. CPC H04L 67/06; H04L 67/1097; H04L 67/1095; H04L 67/2842; H04L 43/0882

(57) ABSTRACT

In an approach for optimizing clustered filesystem lock ordering in multi-gateway supported hybrid cloud environment, a processor identifies a wide area network (WAN) caching gateway topology between a set of nodes distributed in a hybrid cloud environment. A processor identifies a token request made for accessing a file targeted for WAN caching across sites within the hybrid cloud environment. A processor analyzes an importance of block ranges of the token request. A processor assigns a weight to the token request in relative comparison with weights allocated to token requests made by other applications. A processor dynamically modifies a read-ahead algorithm used during token generation to generate tokens for the block ranges of the token request based on the WAN caching gateway topology.

### BACKGROUND OF THE INVENTION

The present invention relates generally to the field of clustered filesystems, and more particularly to optimizing clustered filesystem lock ordering in multi-gateway supported hybrid cloud environment.

Distributed locking provides a consistent view of a filesystem or file system. Distributed locking can be implemented via multiple ways, e.g., using token-based lock management. Typically, a file system manager node performs the duties of the token manager server. The token management server coordinates access to files on shared disks by granting tokens that convey the right to read or write the data or metadata of a file. This service ensures the consistency of the file system data and metadata when different nodes access the same file.

The first time a node accesses a file the node must send a request to the token management server to obtain a corresponding read or write token. After having been granted the token, a node may continue to read or write to the file without requiring additional interaction with the token management server. This continues until an application on another node attempts to read or write to the same region in the file.

The normal flow for a token is: (1) an access request of a block range is sent by the application server to the token management server; (2) the token management server either returns a granted token or a list of the nodes that are holding conflicting tokens; and (3) the token management function at the requesting node has the responsibility to communicate with all nodes holding a conflicting token and get them to relinquish the token, this relieves the token server of having to deal with all nodes holding conflicting tokens. In order for a node to relinquish a token, the daemon must give it up. First, the daemon must release any locks that are held using this token. This may involve waiting for any input/output (I/O) to complete.

Wide area network (WAN) caching, as used herein, involves copying files from a remote file system to a local file system over an unreliable, high latency WAN network. Some remote and local file systems can be spread across geographies. One implementation of WAN caching is Active file management (AFM). AFM is a scalable, high-performance, file system caching layer integrated with a General Parallel File System (GPFS™), which is a cluster file system. AFM allows a user to create associations from a local GPFS™ cluster to a remote cluster or storage, and to define the location and flow of file data to automate the management of the data. This allows the user to implement a single namespace view across sites around the world. AFM uses a home-and-cache model in which a single home provides the primary storage of data, and exported data is cached in a local GPFS™ file system.

AFM-based Async Disaster Recovery is an AFM based fileset-level replication disaster recovery capability to augment the overall business recovery solution. This capability is a strict one-to-one active-passive model. It is represented by two sites—a primary and a secondary. The primary site is a read-writeable fileset where the applications are currently running, and they have read-write access to the data. The secondary site is recommended to be read-only. All data from the primary site is asynchronously replicated to the secondary site. All file user data, metadata, hard links, renames, and clones from the primary are replicated to the secondary. All file system and fileset related attributes such as user, group, or fileset quotas, replication factors, and dependent filesets from the primary are not replicated to the secondary. A consistent point-in-time view of the data in the primary fileset can be propagated in-line to the secondary fileset with the use of fileset based snapshots (psnaps). The recovery point objective (RPO) feature makes it possible to specify the frequency of these snapshots and can alert if it is unable to achieve the set RPO. A minimum RPO time is set to 15 minutes.

### SUMMARY

Aspects of an embodiment of the present invention disclose a method, computer program product, and computer system for optimizing clustered filesystem lock ordering in multi-gateway supported hybrid cloud environment. A processor identifies a wide area network (WAN) caching gateway topology between a set of nodes distributed in a hybrid cloud environment. A processor identifies a token request made for accessing a file targeted for WAN caching across sites within the hybrid cloud environment. A processor analyzes an importance of block ranges of the token request. A processor assigns a weight to the token request in relative comparison with weights allocated to token requests made by other applications. A processor dynamically modifies a read-ahead algorithm used during token generation to generate tokens for the block ranges of the token request based on the WAN caching gateway topology.

In some aspects of an embodiment of the present invention, a processor identifies the WAN caching gateway topology by determining whether the WAN caching gateway topology is a single gateway or a multi-gateway and identifying network characteristics based on monitoring of traffic within the hybrid cloud environment.

In some aspects of an embodiment of the present invention, a processor identifies the token request made for accessing the file targeted for WAN caching across the sites within the hybrid cloud environment by performing a lookup of an index node (inode) of the file for the block ranges of the token request within a WAN caching configured namespace and tagging the token request with a special field denoting a multi-gateway request.

In some aspects of an embodiment of the present invention, analyzing the importance of the block ranges of the token request is based on the lookup of the inode of the file and the analysis comprises analyzing metadata of the file, wherein the importance is stored in an attribute of the metadata.

In some aspects of an embodiment of the present invention, the importance of the block ranges of the token request is based on at least one of data importance, container orchestrator priority, and replication priority.

In some aspects of an embodiment of the present invention, a processor prioritizes WAN caching of tokens generated based on the token request.

In some aspects of an embodiment of the present invention, the importance of the block ranges of the token request is based on a filesystem level policy configuration.

### BRIEF DESCRIPTION OF THE DRAWINGS

FIG. 1 is a flowchart depicting a traditional implementation of WAN caching between sites, as known by a person of skill in the art.

FIG. 2 is a functional block diagram illustrating a distributed data processing environment, in accordance with an embodiment of the present invention.

FIG. 3 is a flowchart depicting operational steps of a multi-gateway lock ordering program, for optimizing clustered filesystem lock ordering in multi-gateway supported hybrid cloud environment, in accordance with an embodiment of the present invention.

FIG. 4 depicts a block diagram of components of a computing device of the distributed data processing environment of FIG. 1, in accordance with an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

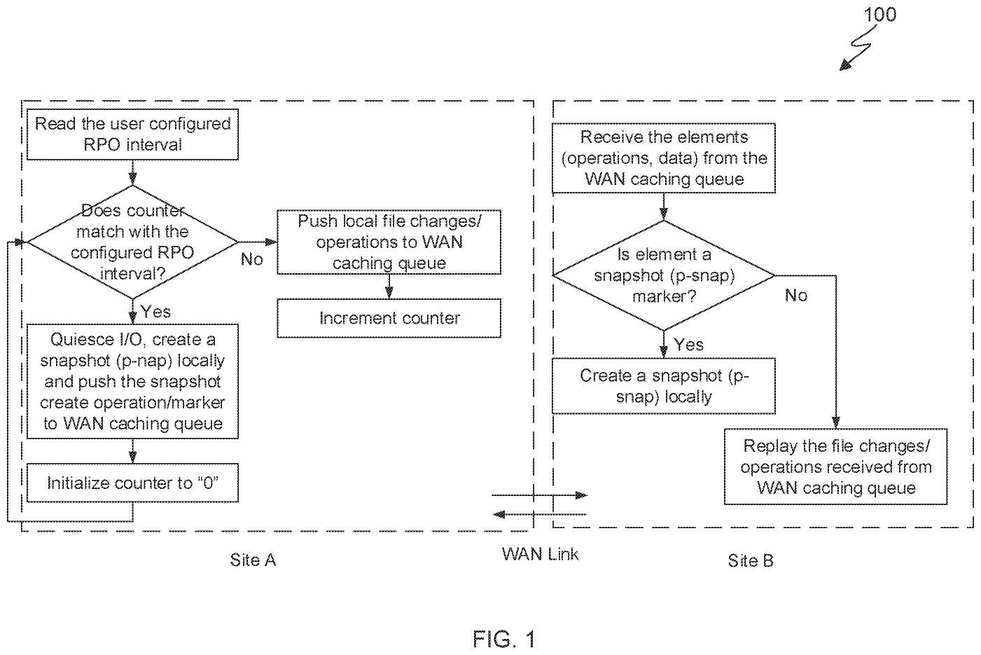

Embodiments of the present invention recognize that in a traditional multi-gateway WAN caching setup, algorithms for efficient write/WAN caching between sites follow one workflow for a single gateway and another workflow for a multi-gateway. FIG. 1 shows a typical implementation 100 of WAN caching between sites, in which this implementation can be scaled across multiple gateways. Gateway is a term that represents a node or server that has a capability to establish communication between sites (i.e., remote and local file systems). After communication is established, the gateway is responsible for maintaining a queue of changes that needs to be pushed between one of the sites. A single gateway is one single node that is doing the copy operation and/or replaying queued changes at the other site. A multi-gateway is a set of nodes that are responsible for the copy operation and/or replaying queued changes at another site.

In an example use case, with site A having four nodes and site B having four nodes, a new file write of size “1G” at site A is received, so it will have to be replicated/cached to site B. For a single gateway, an assigned gateway node at site A, which can be any one of the four nodes, is responsible for replaying this new file to site B. The gateway node seeks locks for the new file data/metadata blocks and a token manager starts serially allocating tokens for block ranges in a read-ahead manner, assuming no other node in site A requests for accessing the file. Usually, when a node seeks locks for a file, the locks/tokens for entire file block ranges are not allocated in one go. The locks/tokens are allocated for a range and once the token for the allocated range is returned, a new token for a next range is provided. This results in a serial remote transfer slow replay and speeds are often limited by workload of single sender and single receiver.

For a multi-gateway, using the same example use case, multiple gateway nodes at site A (two, three, or four nodes in this example use case) are responsible for replaying the new file to site B. The multiple gateway nodes seek locks for the new file data/metadata blocks and a token manager exclusively allocates them the gateway nodes in a round-robin fashion, assuming no other node in site A requests for accessing the file. This avoids the need for lock ping-pong, i.e., a token manager starts allocating tokens for block ranges in a round-robin read-ahead manner since there are no conflicting access requests. If two nodes at site A are designated as gateway nodes, the two nodes split the 1G file into 1 M size chunks and send in a round-robin form. Even though the multi-gateway model offers parallelization, this causes token contention due to read/write-ahead algorithm, which causes delay and increased workload on a token manager. With this traditional implementation, byte+offset (1 M) pair from site A is sent/replayed to each node in a serial fashion. At site B, the data blocks are either received in “ODD” or “EVEN” byte range available for writing. Each node will take a write exclusive lock to write received data blocks to the disk. The token manager will provide required lock ranges to the requesting node.

Due to read/write-ahead algorithms in place, the lock ranges are granted for more than the block ranges requested because the algorithms lacks the intelligence to know that block ranges are parallelized, split, and sent to two different nodes by sender. If token is requested for lock range 0-1 M, then a token manager allocates a token for lock range (0-1.5 M), which conflicts with the lock range requested by another node. This results in token ping-pong with the number of conflicting/ping-pong messages being directly proportional to increase in gateway nodes and results in performance overhead while replicating/replaying changes. This kind of token ping-pong generates un-necessary communications and results in performance loss in the case of a container/cloud workload since most of the container workloads are pipeline based and not all files generated by the pipeline stage are important.

Embodiments of the present invention provide a system and method for optimizing clustered filesystem lock ordering in multi-gateway supported hybrid cloud environment. Embodiments of the present invention perform efficient lock ordering (i.e., efficiently generating tokens for ranges that avoid/minimize locking as opposed to non-efficient traditional write-ahead round-robin based token generation) in a multi-gateway supported hybrid cloud environment based on prioritizing changes, in which priority is based on data importance, container orchestrator priority, etc., pushed to the queue utilized by multiple gateway nodes in order to replay changes between multiple sites. For example, when two or more applications are trying to access the same block ranges, in which one of the applications is Active File Management (AFM), the token request made by AFM is prioritized. In another example in which AFM requested multiple tokens, then the order of the token request is prioritized based on the data importance, container orchestrator priority, etc.

Implementation of embodiments of the invention may take a variety of forms, and exemplary implementation details are discussed subsequently with reference to the Figures.

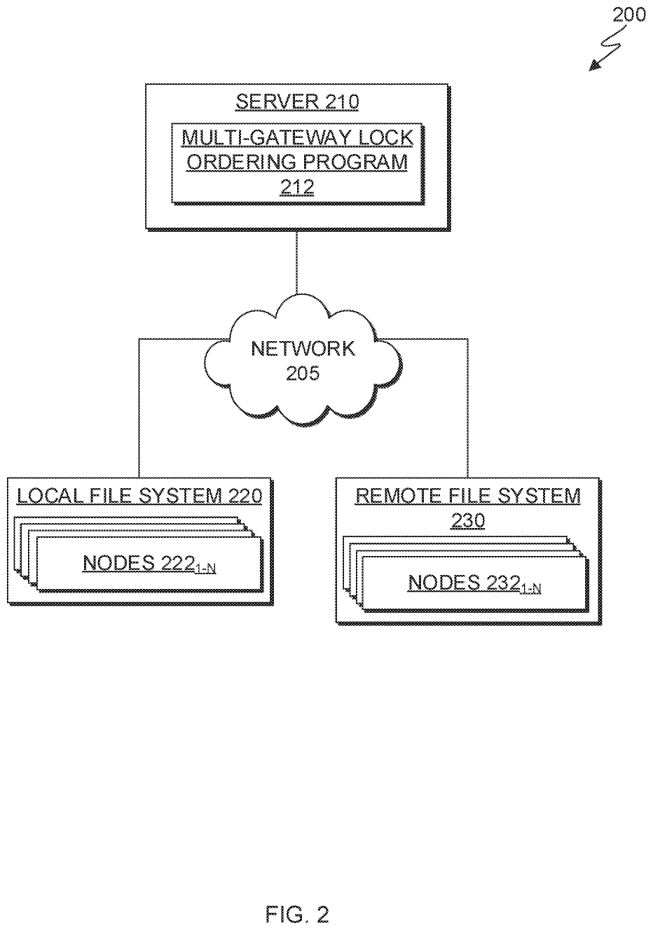

FIG. 2 is a functional block diagram illustrating a distributed data processing environment, generally designated 200, in accordance with one embodiment of the present invention. The term “distributed,” as used herein, describes a computer system that includes multiple, physically distinct devices that operate together as a single computer system. According to embodiments of the present invention, FIG. 2 represents a multi-gateway hybrid cloud environment with multiple gateway nodes across multiple servers/clouds. In the depicted embodiment, FIG. 2 only depicts one local file system and one remote file system, but it is to be understood that there can be any number of file systems that can represent an on-premises local filesystem, private cloud, or public cloud. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 200 includes server 210, local file system 220, and remote file system 230, interconnected over network 205. Network 205 is a WAN, such as the Internet, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between server 210, local file system 220, remote file system 230, and other computing devices (not shown) within distributed data processing environment 200.

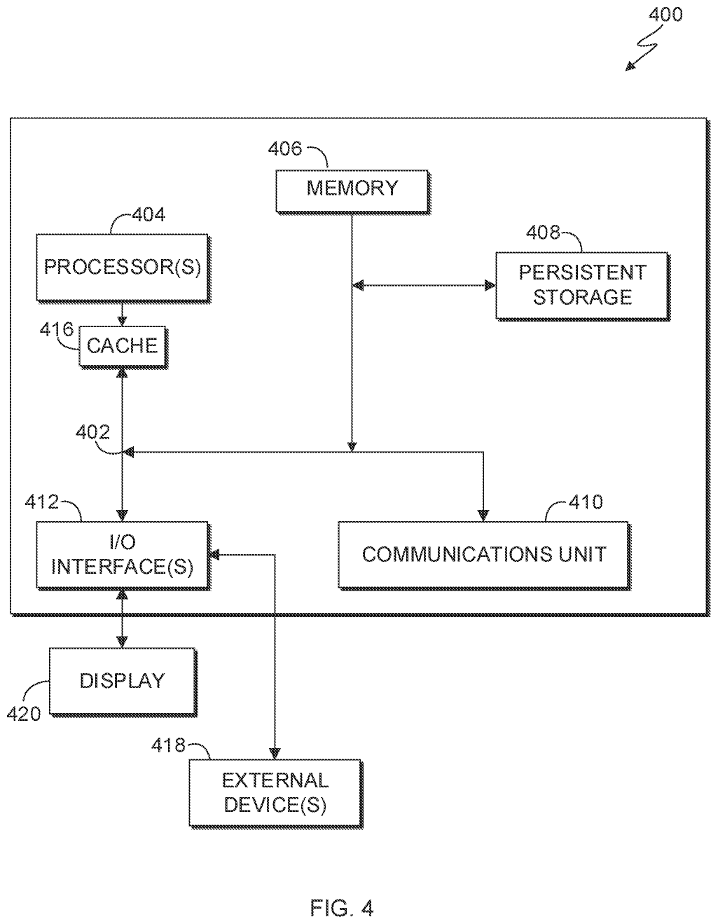

Server 210 operates to run multi-gateway lock ordering program 212. Server 210 can be a standalone computing device, a management server, a web server, a mobile computing device, or any other electronic device or computing system capable of receiving, sending, and processing data. In other embodiments, server 210 can represent a server computing system utilizing multiple computers as a server system, such as in a cloud computing environment. In another embodiment, server 210 can be a laptop computer, a tablet computer, a netbook computer, a personal computer (PC), a desktop computer, a personal digital assistant (PDA), a smart phone, or any programmable electronic device capable of communicating with local file system 220, remote file system 230, and other computing devices (not shown) within distributed data processing environment 200 via network 205. In another embodiment, server 210 represents a computing system utilizing clustered computers and components (e.g., database server computers, application server computers, etc.) that act as a single pool of seamless resources when accessed within distributed data processing environment 200. In the depicted embodiment, server 210 includes multi-gateway lock ordering program 212. Server 210 may include internal and external hardware components, as depicted and described in further detail with respect to FIG. 4.

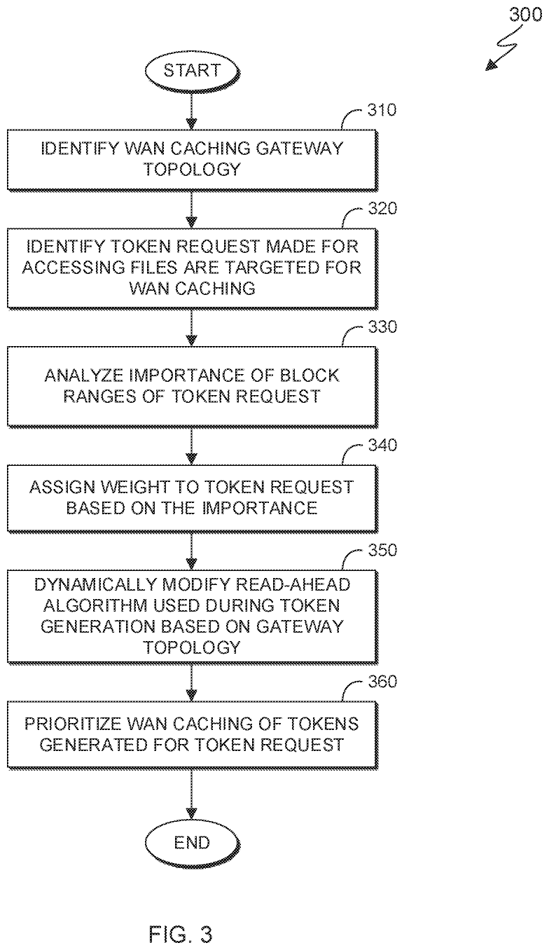

Multi-gateway lock ordering program 212 operates to optimize clustered filesystem lock ordering in a multi-gateway supported hybrid cloud environment. In the depicted embodiment, multi-gateway lock ordering program 212 is a standalone program. In another embodiment, multi-gateway lock ordering program 212 may be integrated into another software product, such as a hybrid cloud software package. In the depicted embodiment, multi-gateway lock ordering program 212 resides on server 110. In another embodiment, multi-gateway lock ordering program 212 may reside on another computing device, server, cloud server, or spread across multiple devices elsewhere (not shown) within distributed data processing environment 200, provided that multi-gateway lock ordering program 212 has access to network 205. Multi-gateway lock ordering program 212 is depicted and described in further detail with respect to FIG. 3.

Local file system 220 operates as a local file system/server that runs nodes 222_{1-N}. Local file system 220 can be a standalone computing device, a management server, a web server, a mobile computing device, or any other electronic device or computing system capable of receiving, sending, and processing data. In other embodiments, local file system 220 can represent a server computing system utilizing multiple computers as a server system, such as in a public or private cloud computing environment. In another embodiment, local file system 220 represents a computing system utilizing clustered computers and components (e.g., database server computers, application server computers, etc.) that act as a single pool of seamless resources when accessed within distributed data processing environment 200. In the depicted embodiment, local file system 220 includes nodes 222_{1-N}, which operate as computing nodes and in which “N” represents any positive integer. One or more of nodes 222_{1-N} operate as assigned gateway nodes that have a capability to establish communication between sites (i.e., local file system 220 and remote file system 230) and are responsible for maintaining a queue of changes that needs to be pushed between one of the sites, i.e., the copy operation and/or replaying queued changes at another site. Local file system 220 may include internal and external hardware components, as depicted and described in further detail with respect to FIG. 4.

Remote file system 230 operates as a remote file system/server that runs nodes 232_{1-N}. Remote file system 230 can be a standalone computing device, a management server, a web server, a mobile computing device, or any other electronic device or computing system capable of receiving, sending, and processing data. In other embodiments, remote file system 230 can represent a server computing system utilizing multiple computers as a server system, such as in a public or private cloud computing environment. In another embodiment, remote file system 230 represents a computing system utilizing clustered computers and components (e.g., database server computers, application server computers, etc.) that act as a single pool of seamless resources when accessed within distributed data processing environment 200. In the depicted embodiment, remote file system 220 includes nodes 232_{1-N}, which operate as computing nodes and in which “N” represents any positive integer. One or more of nodes 232_{1-N} operate as assigned gateway nodes that have a capability to establish communication between sites (i.e., local file system 220 and remote file system 230) and are responsible for maintaining a queue of changes that needs to be pushed between one of the sites, i.e., the copy operation and/or replaying queued changes at another site. Remote file system 230 may include internal and external hardware components, as depicted and described in further detail with respect to FIG. 4.

FIG. 3 is a flowchart 300 depicting operational steps of multi-gateway lock ordering program 212, for optimizing clustered filesystem lock ordering in multi-gateway supported hybrid cloud environment, in accordance with an embodiment of the present invention. It should be appreciated that the process depicted in FIG. 3 illustrates one possible iteration of multi-gateway lock ordering program 212.

In step 310, multi-gateway lock ordering program 212 identifies WAN caching gateway topology. In an embodiment, multi-gateway lock ordering program 212 identifies the gateway topology used for WAN caching configured between a set of nodes distributed in a hybrid cloud environment, e.g., nodes 222_{1-N} of local file system 220 and nodes 232_{1-N} of remote file system 230. In an embodiment, multi-gateway lock ordering program 212 identifies (1) whether the gateway topology is a single gateway or multi-gateway and (2) network characteristics such as network latency and packet drop/error rate. The gateway node(s) act as an interface to this filesystem to perform copy operation. In an embodiment, multi-gateway lock ordering program 212 identifies how many gateways are configured. In an embodiment, multi-gateway lock ordering program 212 identifies the gateway topology based on triggers configurable to administrator commands that enable a user/administrator to manage a gateway node. In an embodiment, multi-gateway lock ordering program 212 identifies the network characteristics based on monitoring the traffic between the cloud environments and standard network tools (such as ping, trace, etc.).

In step 320, multi-gateway lock ordering program 212 identifies a token request is made for accessing files for WAN caching. In an embodiment, multi-gateway lock ordering program 212 identifies if a request for token generation has been initiated by a file that is targeted for WAN caching across sites. i.e., file systems, e.g., cloud environments. In an embodiment, multi-gateway lock ordering program 212 performs a lookup of the index node (inode) of the file, for data blocks for which the token generation request has been submitted, within the WAN caching configured namespace, i.e., a file system that is configured to use WAN caching. If the filesystem is found in the WAN caching configured namespace, multi-gateway lock ordering program 212 tags/labels the token generation request with a special field, i.e., adding an additional header or a special bit, and is passed to a token manager. Multi-gateway lock ordering program 212 tags the request to differentiate this multi-gateway request from a single gateway request. If multiple gateways are configured, then multi-gateway lock ordering program 212 starts tagging the token generation requests made by the WAN caching application, e.g., AFM.

In step 330, multi-gateway lock ordering program 212 analyzes an importance of block ranges of the token generation request. In an embodiment, multi-gateway lock ordering program 212 analyzes the importance of a block range for which token generation request has been submitted based on the lookup of the file inode from step 320. In an embodiment, multi-gateway lock ordering program 212 analyzes metadata of the file, in which the importance of the file can be stored as an attribute. In some embodiments, multi-gateway lock ordering program 212 identifies the importance of the file based on filesystem level policy configuration. In an embodiment, multi-gateway lock ordering program 212 measures the importance of the file based on data importance, container orchestrator priority, replication priority (i.e. the urgency of this file at another site), etc. Data importance can be determined by a flag or attribute in metadata of the file denoting the importance of the data blocks associated with the file.

In step 340, multi-gateway lock ordering program 212 assigns a weight to the request based on the importance. In an embodiment, multi-gateway lock ordering program 212 assigns a weight to the request in relative comparison with weights allocated to token requests made by other applications, i.e., by allocating priority among tokens, in which the priority is based on the weights and the weights are assigned based on relative comparison. In an embodiment, multi-gateway lock ordering program 212 weights the block ranges based on the importance of the file. The token manager can process requests for token generation based on the weight associated with each request.

In step 350, multi-gateway lock ordering program 212 dynamically modifies a read-ahead algorithm used during token generation based on the gateway topology and the tagged token request. In an embodiment, multi-gateway lock ordering program 212 dynamically alters the read-ahead algorithm to generate tokens for exact block ranges based on the gateway topology identified and the tagged token generation request. Traditional algorithms use read-ahead algorithms and read blocks before requested. Multi-gateway lock ordering program 212 dynamically alters the read-ahead algorithm to be interrupted in real-time and instructed to issue tokens only for requested range and not for consecutive blocks.

In step 360, multi-gateway lock ordering program 212 prioritizes WAN caching tokens generated based on the token request made by multiple applications. In an embodiment, multi-gateway lock ordering program 212 provides a scheduler interface, e.g., an external interface, where based on the priority, the tokens are prioritized and issued. For example, if the same block ranges/tokens are requested by different applications, this scheduler will prioritize the application that is associated with WAN caching. In an embodiment, multi-gateway lock ordering program 212 alters token priority in WAN caching pipeline based on the importance, as determined in step 330.

One use case for how embodiments of the present invention enabling prioritization of tokens can improve efficiencies is when a gateway node is down in a multi-gateway topology. Traditionally, all token requests are considered with equal priority, but embodiments of the present invention enable prioritization of tokens, in which prioritization is dependent on an application pipeline at a remote site. If a gateway node is down in a multi-gateway topology, due to either hardware or software failure, multi-gateway lock ordering program 212 considers this case and as a part of recovery generates new tokens based on read-ahead algorithm.

FIG. 4 depicts a block diagram of components of computing device 400, suitable for server 210, local file system 220, and/or remote file system 230 within distributed data processing environment 200 of FIG. 2, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing device 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Programs may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Programs may be downloaded to persistent storage 408 through communications unit 410.

I/O interface(s) 412 allows for input and output of data with other devices that may be connected to server 210, local file system 220, and/or remote file system 230. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

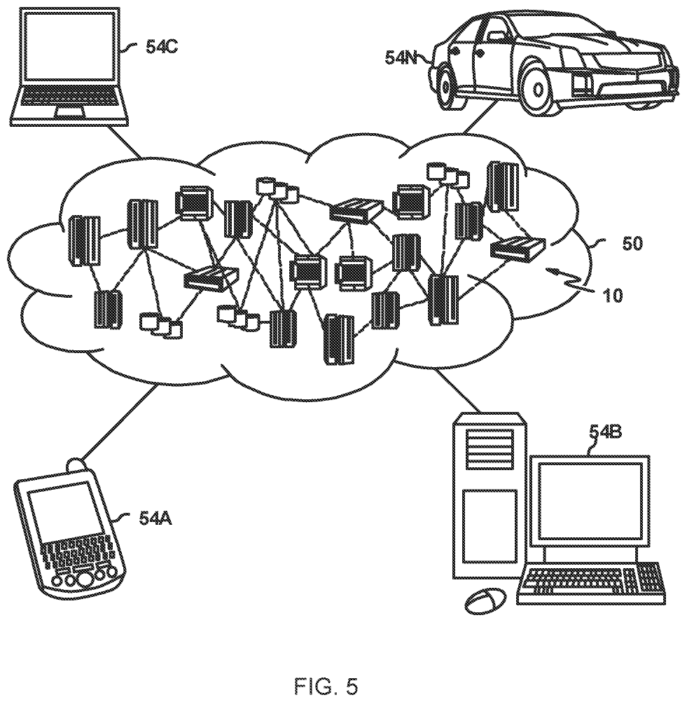

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

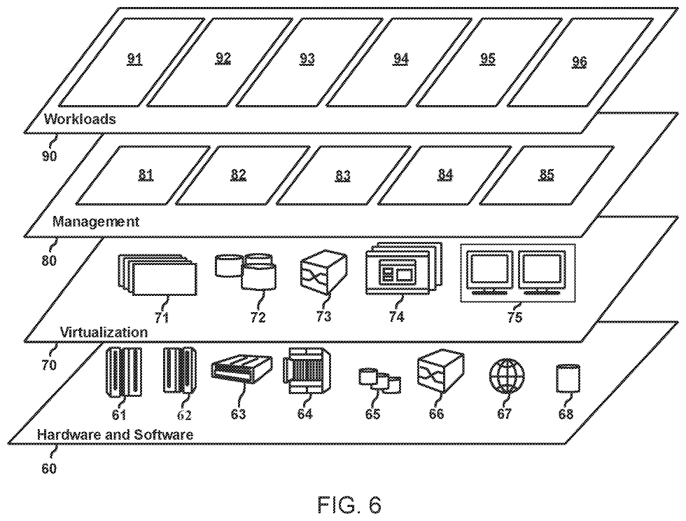

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and multi-gateway lock ordering 96.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying, by one or more processors, a wide area network (WAN) caching gateway topology between a set of nodes distributed in a hybrid cloud environment;
identifying, by the one or more processors, a token request made for accessing a file, wherein the file is targeted for WAN caching across sites within the hybrid cloud environment;
analyzing, by the one or more processors, an importance of block ranges of the token request; and
assigning, by the one or more processors, a weight to the token request in relative comparison with weights allocated to token requests made by other applications.

2. The computer-implemented method of claim 1, wherein identifying the WAN caching gateway topology comprises:
determining, by the one or more processors, whether the WAN caching gateway topology is a single gateway or a multi-gateway; and
identifying, by the one or more processors, network characteristics based on monitoring of traffic within the hybrid cloud environment.

3. The computer-implemented method of claim 1, wherein identifying the token request made for accessing the file targeted for the WAN caching across the sites within the hybrid cloud environment comprises:
performing, by the one or more processors, a lookup of an index node (inode) of the file for the block ranges of the token request within a WAN caching configured namespace; and
tagging, by the one or more processors, the token request with a special field denoting a multi-gateway request.

4. The computer-implemented method of claim 3, wherein analyzing the importance of the block ranges of the token request is based on the lookup of the inode of the file and comprises:
analyzing, by the one or more processors, metadata of the file, wherein the importance is stored in an attribute of the metadata.

5. The computer-implemented method of claim 1, wherein the importance of the block ranges of the token request is based on at least one of data importance, container orchestrator priority, and replication priority.

6. The computer-implemented method of claim 1, further comprising:
prioritizing, by the one or more processors, WAN caching of tokens generated based on the token request.

7. The computer-implemented method of claim 1, wherein the importance of the block ranges of the token request is based on a filesystem level policy configuration.

8. A computer program product comprising:
one or more computer readable storage media and program instructions collectively stored on the one or more computer readable storage media, the stored program instructions comprising:
program instructions to identify a wide area network (WAN) caching gateway topology between a set of nodes distributed in a hybrid cloud environment;
program instructions to identify a token request made for accessing a file, wherein the file is targeted for WAN caching across sites within the hybrid cloud environment;
program instructions to analyze an importance of block ranges of the token request; and
program instructions to assign a weight to the token request in relative comparison with weights allocated to token requests made by other applications.

9. The computer program product of claim 8, wherein the program instructions to identify the WAN caching gateway topology comprise:
program instructions to determine whether the WAN caching gateway topology is a single gateway or a multi-gateway; and
program instructions to identify network characteristics based on monitoring of traffic within the hybrid cloud environment.

10. The computer program product of claim 8, wherein the program instructions to identify the token request made for accessing the file targeted for the WAN caching across the sites within the hybrid cloud environment comprise:
program instructions to perform a lookup of an index node (inode) of the file for the block ranges of the token request within a WAN caching configured namespace; and
program instructions to tag the token request with a special field denoting a multi-gateway request.

11. The computer program product of claim 10, wherein the program instructions to analyze the importance of the block ranges of the token request is based on the lookup of the inode of the file and comprise:
program instructions to analyze metadata of the file, wherein the importance is stored in an attribute of the metadata.

12. The computer program product of claim 8, wherein the importance of the block ranges of the token request is based on at least one of data importance, container orchestrator priority, and replication priority.

13. The computer program product of claim 8, further comprising:
program instructions to prioritize WAN caching of tokens generated based on the token request.

14. (canceled)

15. A computer system comprising:
one or more computer processors;
one or more computer readable storage media;
program instructions collectively stored on the one or more computer readable storage media for execution by at least one of the one or more computer processors, the stored program instructions comprising:
program instructions to identify a wide area network (WAN) caching gateway topology between a set of nodes distributed in a hybrid cloud environment;
program instructions to identify a token request made for accessing a file, wherein the file is targeted for WAN caching across sites within the hybrid cloud environment;
program instructions to analyze an importance of block ranges of the token request; and
program instructions to assign a weight to the token request in relative comparison with weights allocated to token requests made by other applications.

16. The computer system of claim 15, wherein the program instructions to identify the WAN caching gateway topology comprise:
program instructions to determine whether the WAN caching gateway topology is a single gateway or a multi-gateway; and
program instructions to identify network characteristics based on monitoring of traffic within the hybrid cloud environment.

17. The computer system of claim 15, wherein the program instructions to identify the token request made for accessing the file targeted for the WAN caching across the sites within the hybrid cloud environment comprise:
program instructions to perform a lookup of an index node (inode) of the file for the block ranges of the token request within a WAN caching configured namespace; and
program instructions to tag the token request with a special field denoting a multi-gateway request.

18. The computer system of claim 17, wherein the program instructions to analyze the importance of the block ranges of the token request is based on the lookup of the inode of the file and comprise:
program instructions to analyze metadata of the file, wherein the importance is stored in an attribute of the metadata.

19. The computer system of claim 15, wherein the importance of the block ranges of the token request is based on at least one of data importance, container orchestrator priority, and replication priority.

20. The computer system of claim 15, further comprising:
program instructions to prioritize WAN caching of tokens generated based on the token request.

21. The computer-implemented method of claim 1, further comprising:
dynamically modifying, by the one or more processors, a read-ahead algorithm used during token generation to generate tokens for the block ranges of the token request based on the WAN caching gateway topology.
